(19) United States
(12) Patent Application Publication
(10) Pub. No.: US 2021/0173241 A1
(43) Pub. Date: Jun. 10, 2021

(54) POLYMER-DISPERSED, LIQUID CRYSTAL FILMS AND SYSTEMS FOR SHEAR STRESS MEASUREMENT AND RELATED METHODS

(71) Applicants: University of Washington, Seattle, WA (US); Kent State University, Kent, OH (US)

(72) Inventors: Dana Dabiri, Seattle, WA (US); John West, Kent, OH (US); Junren Wang, Kent, OH (US)

(73) Assignees: University of Washington, Seattle, WA (US); Kent State University, Kent, OH (US)

(21) Appl. No.: 17/247,330

(22) Filed: Dec. 7, 2020

Related U.S. Application Data
(60) Provisional application No. 62/945,475, filed on Dec. 9, 2019.

(51) Int. Cl. G02F 1/1334; C09K 19/02; C09K 19/54; G01M 9/06; G02F 1/1335

(52) U.S. Cl. CPC G02F 1/1334; C09K 19/02; C09K 19/544; G01M 9/067; G02F 2203/07; C09K 2219/03; G02F 2203/01; G02F 2202/023; G02F 1/133507

(57) ABSTRACT

Films, systems, and methods for measuring shear stress are described. In an embodiment, the film comprises an optically transmissive polymer matrix disposed on a substrate; and a liquid crystal dispersed in the optically transmissive polymer matrix, wherein at least a portion of the liquid crystal protrudes from or is exposed on a side of the optically transmissive polymer matrix opposite the substrate.

### CROSS-REFERENCE(S) TO RELATED APPLICATION

This patent application claims the benefit of U.S. Provisional Patent Application No. 62/945,475, filed Dec. 9, 2019, the contents of which are hereby incorporated by reference in their entirety.

### BACKGROUND

Shear stress and pressure are the two predominant forces that act on any aerodynamic surface. These two forces have been intensively studied because of their close influence on aircraft costs. Pressure acts perpendicular to the body surface while shear stress acts tangentially to the body surface. In general, these forces are studied and quantified using sensors in a wind tunnel. A good sensor should 1) be non-intrusive (i.e., does not disturb the flow over a surface); 2) have high spatial resolution; 3) with good temporal resolution; and 4) be reversible.

Pressure is conventionally measured by pressure sensitive paint. In 1985, researchers at the University of Washington-Seattle developed a method to monitor oxygen concentration changes based on phosphorescence quenching with the goal of monitoring oxygen concentration in blood or other fluids. Later, this concept of luminescence quenching was modified to map the pressure distribution over aerodynamic surfaces in a wind tunnel. This oxygen-permeable luminescent coating is called pressure-sensitive paint.

Compared with pressure measurement, shear stress measurement is more challenging due to the limitations of traditional methods. Such traditional methods of measuring shear stress include Preston tubes, hot-wire anemometers, and micro-electromechanical system (MEMS), etc. Although being accurate and reliable, these methods suffer from invasive disturbance, or lack the simplicity to install and calibrate, or provide only point measurements of shear stress.

Previous work has taken advantages of the optical anisotropy or birefringence of nematic liquid crystal (LC) and the dependence of their anisotropy on shear stress. In such work, nematic LC-E7 was coated on a rubbed polyvinyl alcohol (PVA) film. The LCs aligned themselves with the rubbing direction of PVA film. When a shear stress was applied across the test surface, the LC coating was twisted along the direction of the shear stress, resulting in a birefringence change and leading to the light transmission through the crossed polarizers.

Although this method provides the information about degree of twisting, it cannot tell the direction of the applied shear stress and cannot provide repeatable measurement because the exposed LC film cannot return to its original state after testing with air flow.

Accordingly, there is presently a need for films, systems, and methods for determining shear stress on a surface that provide a shear stress magnitude and direction that is also repeatable and non-invasive.

### SUMMARY

Toward that end, the present disclosure provides an approach based on the dynamic optical anisotropy or birefringence of polymer-dispersed liquid crystal (PDLC) coatings to address these and related challenges.

Accordingly, in an aspect, the present disclosure provides a film for measuring shear stress. In an embodiment, the film comprises an optically transmissive polymer matrix disposed on a substrate; and a liquid crystal dispersed in the optically transmissive polymer matrix, wherein at least a portion of the liquid crystal protrudes from or is exposed on a side of the optically transmissive polymer matrix opposite the substrate.

In another aspect, the present disclosure provides a system for measuring shear stress. In an embodiment, the system comprises a film comprising: an optically transmissive polymer matrix disposed on a substrate; and a liquid crystal dispersed in the optically transmissive polymer matrix, wherein at least a portion of the liquid crystal protrudes from or is exposed on a side of the optically transmissive polymer matrix opposite the substrate; a polarized light source positioned to emit polarized light onto the film; and a sensor configured to generate a signal based on optical anisotropy of light received by the sensor from the film.

In another aspect, the present disclosure provides a method of measuring an amount of sheet stress on a surface. In an embodiment, the method comprises exposing the surface to shear stress, wherein a film comprising an optically transmissive polymer matrix; and a liquid crystal dispersed in the optically transmissive polymer matrix is disposed on the surface; illuminating the film with polarized light; measuring an amount of optical anisotropy in light reflected off of the film; and correlating the amount of optical anisotropy with an amount of sheer stress.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1A is an image of a polymer-dispersed liquid crystal (PDLC) film, in accordance with an embodiment of the present disclosure;

FIG. 1B is an image of another PDLC film, in accordance with an embodiment of the present disclosure;

FIG. 1C is a schematic illustration of a liquid crystal domain of a PDLC film, in accordance with an embodiment of the present disclosure;

FIG. 1D is an image of the PDLC film of FIG. 1B observed between crossed polarizers, in accordance with an embodiment of the present disclosure;

FIG. 1E illustrates a comparison of birefringence of the PDLC film of FIG. 1A and wind speed of, in accordance with an embodiment of the present disclosure;

FIG. 1F illustrates a comparison of birefringence of the PDLC of FIG. 1B and wind speed, in accordance with an embodiment of the present disclosure;

FIG. 2A is a schematic illustration of a liquid crystal domain of a PDLC film, in accordance with an embodiment of the present disclosure;

FIG. 2B is an image of a PDLC film, in accordance with an embodiment of the present disclosure, observed between crossed polarizers;

FIG. 2C is an image of a PDLC film, in accordance with an embodiment of the present disclosure;

FIG. 2D is an image of the PDLC film of FIG. 2C observed between crossed polarizers, in accordance with an embodiment of the present disclosure;

FIG. 2E is an image of a PDLC film, in accordance with an embodiment of the present disclosure;

FIG. 2F is an image of the PDLC film of FIG. 2E observed between crossed polarizers, in accordance with an embodiment of the present disclosure;

FIG. 2G is an image of a PDLC film, in accordance with an embodiment of the present disclosure;

FIG. 2H is an image of the PDLC film of FIG. 2G observed between crossed polarizers, in accordance with an embodiment of the present disclosure;

FIG. 3 illustrates a comparison of birefringence of a PDLC film, in accordance with an embodiment of the disclosure, and wind speed;

FIG. 4 illustrates an optical response of a PDLC film, in accordance with an embodiment of the present disclosure, in response to an applied stress measured with light polarized parallel and perpendicular to the stress direction;

FIG. 5 illustrates an optical response of a PDLC film, in accordance with an embodiment of the disclosure, as a function of applied weight;

FIG. 6 illustrates optical response of a PDLC film, in accordance with an embodiment of the disclosure, as a function of applied weight;

FIG. 7A includes images of a PDLC film, in accordance with an embodiment of the present disclosure, responding to air flow over the PDLC film;

FIG. 7B schematically illustrates partially exposed liquid crystals of a PDLC film, in accordance with an embodiment of the disclosure, responding to shear stress;

FIG. 8A is a schematic illustration of a system for measuring shear stress, in accordance with an embodiment of the present disclosure;

FIG. 8B is a schematic illustration of a light source, diffuser, circular polarized, PDLC film, QuadView with linear polarizers, and CCD camera of a system, in accordance with an embodiment of the present disclosure;

FIG. 8C is a cross-section view of a system including a wind tunnel, in accordance with an embodiment of the present disclosure, configured to operate in transmission mode;

FIG. 8D is a cross-section view of a system including a wind tunnel, in accordance with an embodiment of the present disclosure, configured to operate in reflection mode;

FIG. 8E is an image of a display of a system, in accordance with an embodiment of the present disclosure, showing magnitude and direction of shear stress on a surface;

FIG. 8F is a schematic illustration of a system, in accordance with an embodiment of the present disclosure;

FIG. 9A is an image of birefringence of a PDLC film, in accordance with an embodiment of the present disclosure, as measured by a system of the present disclosure prior to exposure to wind and shear stress over the PDLC film;

FIG. 9B is an image of birefringence of the PDLC film of FIG. 9A when exposed to wind and shear stress, in accordance with an embodiment of the present disclosure;

FIG. 9C is an image of birefringence of the PDLC film of FIG. 9A after being exposed to wind, in accordance with an embodiment of the present disclosure;

FIG. 10A is an image of a PDLC film, in accordance with an embodiment of the disclosure, exposed to air expelled from an air jet;

FIG. 10B is an image of a PDLC film, in accordance with an embodiment of the disclosure, exposed to air expelled from an air jet;

FIG. 10C is an image of a PDLC film, in accordance with an embodiment of the disclosure, exposed to air expelled from an air jet;

FIG. 10D is an image of a PDLC film, in accordance with an embodiment of the disclosure, exposed to air expelled from an air jet;

FIG. 11 schematically illustrates elliptically polarized light, where ϕ is the extinction angle measured from the slow axis (larger refractive index) to the horizontal (with respect to the linear polarizer), in accordance with an embodiment of the disclosure; and

FIG. 12 schematically illustrates different polarizing nano-wire grids, in accordance with an embodiment of the present disclosure.

### DETAILED DESCRIPTION

The present disclosure generally relates to polymer-dispersed liquid crystal (PDLC) films or coatings and systems and methods of measuring shear stress on a surface using such PDLC coatings. As discussed in greater detail further herein, the PDLC coatings of the present disclosure are configured to generate optical anisotropy, such as birefringence or scattering, in response to sheer stress. By measuring such optical anisotropies, an amount and, in certain embodiments, direction of shear stress on the coating can be determined.

As described further herein, the PDLC films of the present disclosure are 1) non-intrusive (i.e. does not disturb the flow over a surface); 2) have high spatial resolution; 3) with good temporal resolution; and 4) are reversible.

### PDLC Coatings

In an aspect, the present disclosure provides PDLC coatings or films. As discussed further herein, such PDLC films are suitable for measuring shear stress. Because the PDLC films, such as PDLC thin films, can be disposed directly on a surface or substrate they are generally non-intrusive and do not substantially alter the shape or outline of a surface of substrate to be tested. Additionally, because each portion of the PDLC film includes liquid crystal dispersed therein, such as in the form of liquid crystal domains, the PDLC film has high spatial resolution and response to applied shear stress. As described in the Examples of the present application, such PDLC films are also reversible within ranges of applied shear stress and show good (i.e. quick) temporal resolution.

In an embodiment, the PDLC films comprise an optically transmissive polymer matrix disposed on a substrate. In an embodiment, the PDLC films are formed by phase separation of a homogeneous solution of the liquid crystal and polymer. This can be accomplished in several ways. For example, the liquid crystal can be dissolved in a polymer precursor such as an uncured epoxy resin. The epoxy resin can then be polymerized either thermally or with UV irradiation. As the molecular weight of the polymer increases, the solubility of the liquid crystal generally decreases and eventually phase separates, forming droplets in the curing polymer resin. As the polymer continues to cure it gels, locking in the droplet morphology.

The morphology and physical properties of the resulting PDLC film can be controlled in multiple ways. The type and relative concentration of the liquid crystal and polymer can be adjusted. The lower the solubility of the LC in the optically transmissive polymer matrix, the quicker the phase separation generally occurs, and the larger the resulting droplets. Also, as the concentration of the liquid crystal is increased, the density and size of the droplet also generally increases. For thermally cured systems, it has been found that the droplet density and size are inversely proportional to the cure temperature. Finally, for UV-cured polymers, light intensity has a large impact on the final morphology with smaller droplets generally resulting from higher cure intensities.

PDLC films can also be fabricated by using non-crosslinked, thermoplastic polymers. These polymers can be melted or dissolved in a suitable solvent. While the liquid crystal can be dissolved in the polymer melt, this approach is rarely used in practice to form a homogeneous solution. Rather, the liquid crystal and the thermoplastic polymer, such as polymethylmethacrylate or polystyrene, are dissolved in a common solvent. Subsequent evaporation of the solvent results in the phase separation of the liquid crystal, droplet formation, and polymer gelation. Interestingly, these PDLC films can be heated above the polymer melting point to re-dissolve the liquid crystal in the polymer. Subsequent cooling results in reformation of the droplets. The rate of cooling can be used to control the PDLC morphology with smaller droplets formed at fast cooling rates.

In addition to the droplet density, size and shape, PDLC film physical properties depend at least in part on the liquid crystal and polymer used. For most electro-optic applications for which liquid crystals were originally designed, a couple of factors may be considered. Enhanced light scattering occurs when the PDLC film droplet size is on the order of the wavelength of light. Also, the largest contrast of the PDLC film is achieved when the refractive index of the polymer matrix is matched with the ordinary refractive index of the liquid crystal. In this case, in the absence of an externally applied force, the droplets assume a random orientation. Light shining through the PDLC film encounters many different indices of refraction from the polymer and from the many orientations of the liquid crystal director axes and is, therefore, scattered. In an embodiment, the PDLC film appears opaque, or “milky white” to an observer. When an external force is applied to the PDLC film, such as an electric field or a shear force, the liquid crystals orient themselves in the same direction. When the indices of refraction between the liquid crystals along their director axis and the polymer match, the PDLC film appears transparent, and the light is able to pass through.

Alternatively, an effective birefringence of the PDLC films may be used with a polarizer and analyzer to produce contrast in a stressed film. In this case the liquid crystal droplets are either much smaller or much larger than the wavelength of light to reduce light scattering. In the unstressed state the liquid droplets are randomly aligned, and the average birefringence is minimal. The applied stress elongated the liquid crystal droplet along the direction of stress and the elastic properties of the liquid crystal result in the director aligning along this same direction producing a birefringence that, over a proscribed range, changes regularly with the applied stress.

An operational temperature range of the PDLC film is most dependent on the temperature range of the liquid crystal, such as a nematic liquid crystal or mixture of nematic liquid crystals, used to form the PDLC film. The liquid crystal display industry has provided formulations of many liquid crystal mixtures that operate over broad temperature range, starting well below room temperature and extending well above 100° C.

The ability to mechanically stress the PDLC film is dependent of the flexibility and elasticity of the polymer used to form the PDLC film and the morphology of the system. The flexibility of the polymer can be controlled by controlling the type of polymer. For example, polysiloxanes tend to be much more flexible than highly crosslinked epoxies. The flexibility of a specific polymer can be adjusted by varying the molecular weight, where generally the lower the molecular weight the higher the flexibility, and by controlling an amount of crosslinking, where more crosslinking generally reduces the flexibility and increases the elasticity. The elasticity of the polymer allows for the PDLC film to return to a relaxed state once the force is no longer being applied based on surface interactions at the droplet wall and the resting spherical shape of the droplets. This results in a reversible sensor.

As noted above, the polymer for the PDLC film should be chosen such that its index of refraction matches or approximately matches the liquid crystal index of refraction along the director axis, which typically ranges from 1.48 to 1.54. This ensures that, as the liquid crystals align themselves to the polymer, the light passing through the sample encounters closer indices of refraction, and thus more light is allowed through. Thus, the birefringence itself becomes a measure of the applied shear force.

In addition to the properties listed above, the polymer should be highly transparent with little or no light-scattering, as this detracts from the liquid crystal's scattering abilities. The polymer should have good film-formation abilities and should adhere well to the support structure. The polymer should have good mechanical properties, such as high elasticity and low brittleness. The polymer should be generally chemically inert to the liquid crystal, as this helps ensure purity of the liquid crystal droplets. While it is desirable to have high miscibility between the liquid crystal and liquid polymer, it is undesirable to have contamination of the solid polymer by the liquid crystal. However, in the cases of most PDLC films, some contamination does occur, resulting in slight changes of physical properties such as the refractive index or the glass transition temperature.

The optically transmissive polymer matrix can include a polymer or combination of polymers configured to transmit light therethrough. In an embodiment, the optically transmissive polymer matrix is translucent. In an embodiment, the optically transmissive polymer matrix is transparent. In an embodiment the optically transmissive polymer matrix is transmissive to light including visible light (e.g. in a range of about 400 nm to about 700 nm), ultraviolet light (e.g. in a range of about 10 nm to about 400 nm), and infrared light (e.g. in a range of about 700 nm to about 1 mm).

In an embodiment, the optically transmissive polymer matrix includes a polymer selected from the group consisting of poly(dimethylsiloxane), poly(methylmethacrylate), poly(urethanes), poly(styrene) and combinations thereof. In an embodiment, the optically transmissive polymer matrix is a poly(dimethylsiloxane) and the curing agent comprises a vinyl moiety. In an embodiment the curing agent comprises a functional oligomer.

In an embodiment, the optically transmissive polymer matrix comprises a crosslinked epoxy. In an embodiment, the epoxy is selected from a UV-cured and a thermally cured epoxy. In an embodiment, the optically transmissive polymer matrix comprises a thermoplastic polymer. In an embodiment, the optically transmissive polymer matrix comprises a thermoplastic resin.

In an embodiment, the optically transmissive polymer matrix is flexible or pliable such that it deforms, such as reversibly deforms, in response to shear stress. In this regard, the PDLC film defines one or more liquid crystal stress-responsive structures. Such flexibility or pliability allows for the optically transmissive polymer matrix to deform in response to shear stress and return to or close to its original shape, thus allowing for repeatable or nearly repeatable measurements of shear stress.

As discussed further herein with respect to the Examples of the present application, in an embodiment, the optically transmissive polymer matrix is crosslinked with a curing agent. As shown in the Examples, a degree of crosslinking of the optically transmissive polymer matrix, such as measured by a weight:weight ratio, can affect the hardness or flexibility of the optically transmissive polymer matrix, which can in turn affect the optical anisotropy of the PDLC films and their reversibility. In an embodiment, a weight:weight ratio of an optically transmissive polymer of the optically transmissive polymer matrix to the curing agent is in a range of about 10:1 to about 100:1.

As above, in an embodiment, the PDLC film is disposed on a substrate. In an embodiment, the substrate is selected from the group consisting of glass, steel, aluminum, and combinations thereof. In an embodiment, the substrate is a portion of a vehicle, such as a portion of an airplane, an automobile, a boat, and the like, or part simulating a vehicle. In an embodiment, the substrate is a portion of a fluidic device, such as a microfluidic device, a medical device, and the like, or part simulating a fluidic device.

The PDLC films of the present disclosure include a liquid crystal dispersed in the optically transmissive polymer matrix. Without wishing to be bound by theory, it is believed that the optically transmissive polymer matrix in which the liquid crystal is dispersed retains the liquid crystal in the PDLC film such that the liquid crystal is not displaced from the substrate in response to sheer stress. In this regard, the PDLC film has at least partially reversible response to shear stress and may be used a number of times to measure shear stress.

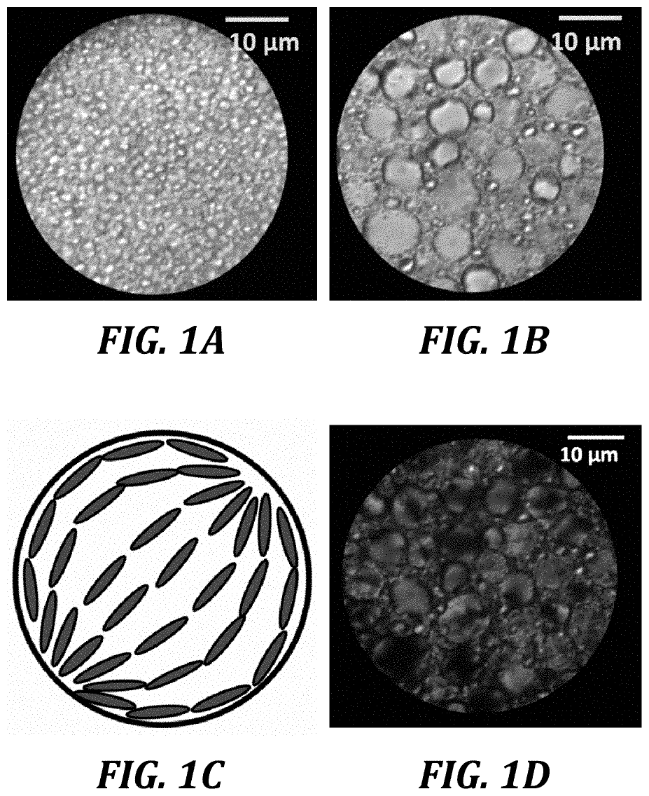

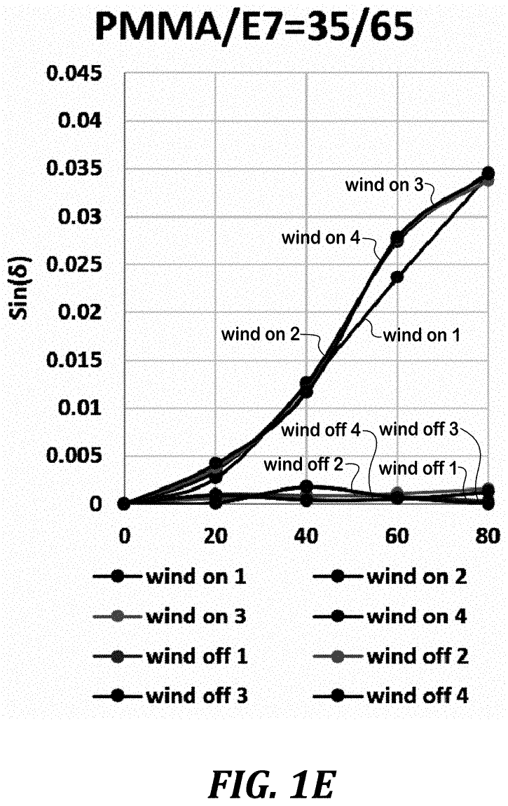

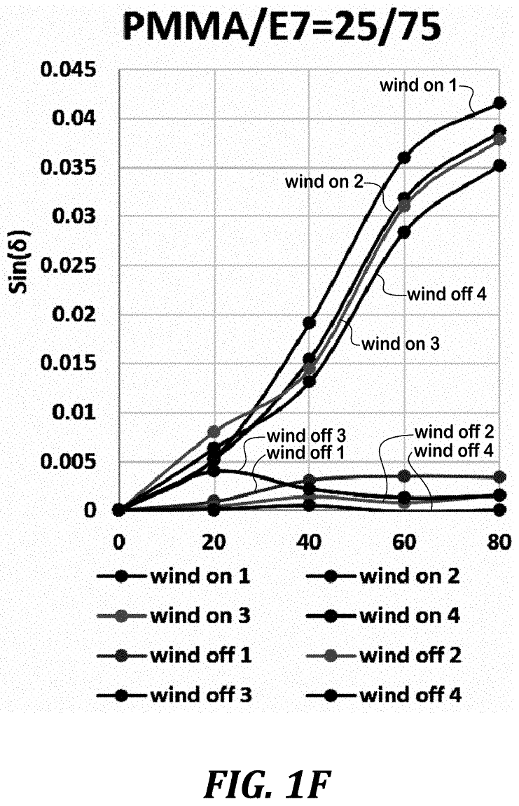

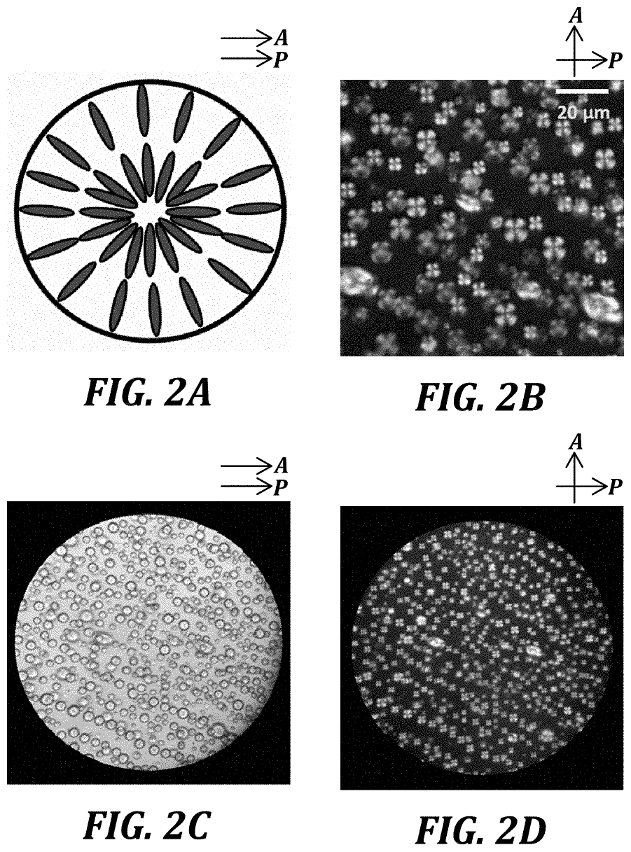

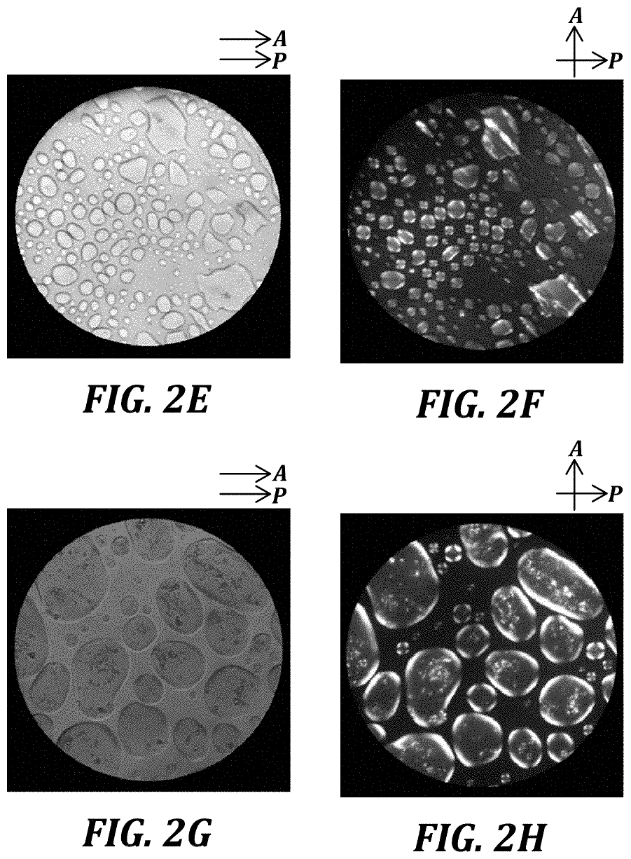

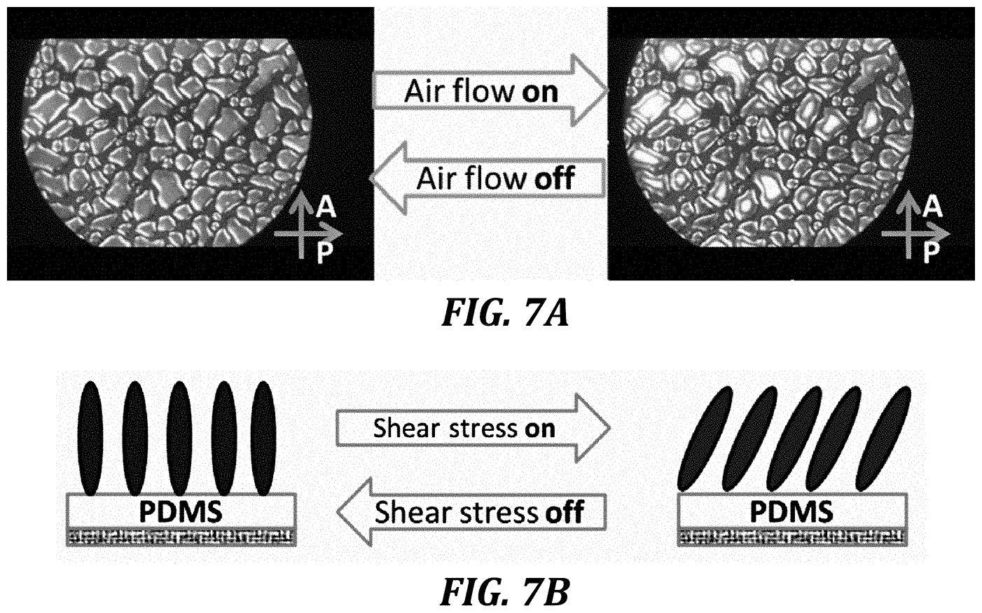

In an embodiment, the liquid crystal dispersed in the optically transmissive polymer matrix defines a plurality of liquid crystal domains distributed within the optically transmissive polymer matrix. Such domains can be seen, for example, in FIGS. 1A, 1B, 1D, and 2B-2H. In an embodiment, the liquid crystal, such as disposed in a plurality of liquid crystal domains, is either fully encased within the polymer as a distribution of droplets or is at least partially exposed to a surrounding environment of the PDLC film. In the latter case, at least a portion of the liquid crystal protrudes from or is exposed on a side of the optically transmissive polymer matrix opposite the substrate. See, for example, FIGS. 7A and 7B. Without wishing to be bound by theory, it is believed that by being exposed to the surrounding environment, the liquid crystal is exposed to shear stress on the PDLC film and is, accordingly, more responsive to the shear stress and provides more optical anisotropy in response to the shear stress than if the liquid crystal were totally encapsulated within the polymer matrix. While the examples of the present disclosure discuss partially exposed liquid crystal domains, it will be understood that other configurations are possible, such as where some or all of the liquid crystal domains of the plurality of liquid crystal domains are fully encased within the optically transmissive polymer matrix.

In an embodiment, an average diameter of the plurality of liquid crystal domains is in a range of about 2 μm to about 30 μm. In an embodiment, the average diameter of the plurality of liquid crystal domains is in a range of about 3 μm to about 25 μm, about 5 μm to about 20 μm, or 10 μm to about 15 μm. In an embodiment, an average thickness of the plurality of liquid crystal domains is in a range of about 5 μm to about 15 μm. In an embodiment, the average diameter of the plurality of liquid crystal domains is in a range of about 1 μm to about 100 μm. In an embodiment, the average diameter of the plurality of liquid crystal domains is in a range of about 0.1 μm to about 5 μm. Such relatively small-diameter liquid crystal domains do not generally scatter light, thus making interpretation of the data easier.

In an embodiment, the liquid crystal is radially aligned within the plurality of liquid crystal domains. In this regard and as shown in FIG. 2A, an axis of liquid crystals within the liquid crystal domain are orthogonal to a polymer matrix-liquid crystal interface. Such a configuration is in contrast to the liquid crystal domain schematically illustrated in FIG. 1C.

In an embodiment, a weight:weight ratio of the optically transmissive polymer matrix to the liquid crystal determines, at least in part, whether at least a portion of the liquid crystal protrudes from or is exposed on a side of the optically transmissive polymer matrix opposite the substrate. In an embodiment, a weight:weight ratio of the optically transmissive polymer matrix to the liquid crystal is about 0.5:1 to about 5:1. In an embodiment, a weight:weight ratio of the optically transmissive polymer matrix to the liquid crystal is about 2:1.

As above, the PDLC films of the present disclosure include a liquid crystal. The liquid crystal can include any liquid crystal suitable to provide optical anisotropy in response to sheer stress when dispersed in an optically transmissive polymer matrix. In an embodiment, the liquid crystal is a nematic liquid crystal. In an embodiment, the liquid crystal is a single-component liquid crystal. Such a single-component liquid crystal is in contrast to a liquid crystal comprising a number of different types liquid crystal components and, instead, comprises a single liquid crystal component. In an embodiment, the liquid crystal comprises an E7 liquid crystal, such as from obtained from Jiangsu Hecheng Display Technology Co. LTD.

### Systems

In another aspect, the present disclosure provides a system for measuring shear stress. In an embodiment, the system includes a polarized light source positioned to emit polarized light onto a sample, such as a PDLC film disposed on a surface or substrate; and a sensor configured to generate a signal based on optical anisotropy of light received by the sensor from the film.

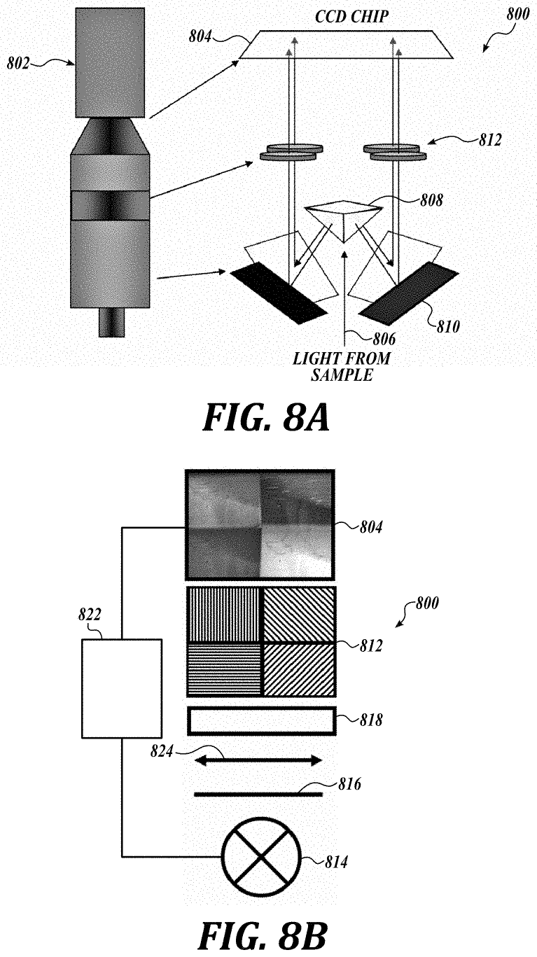

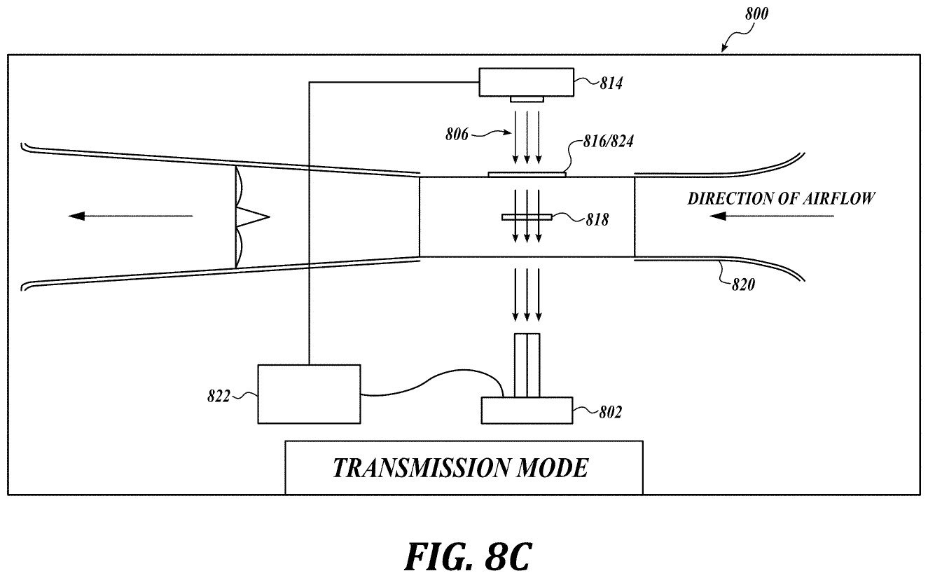

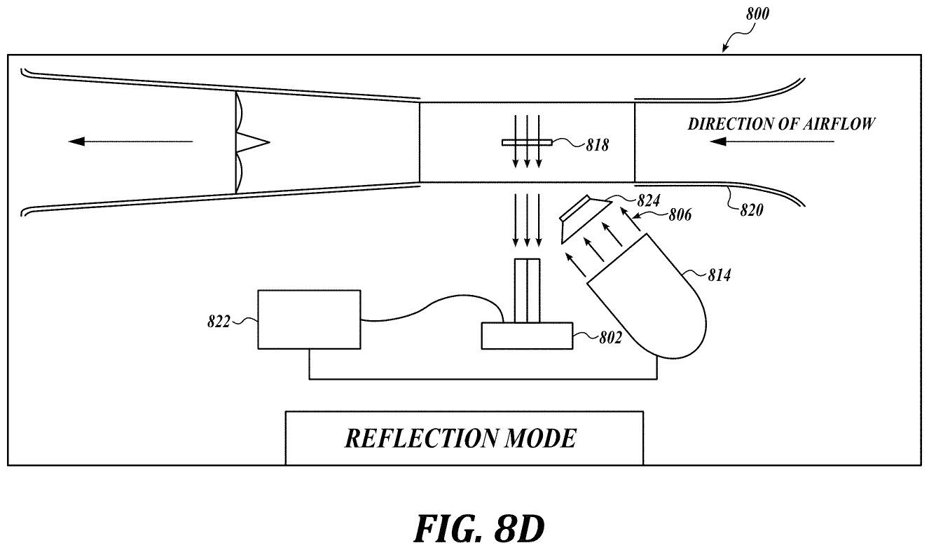

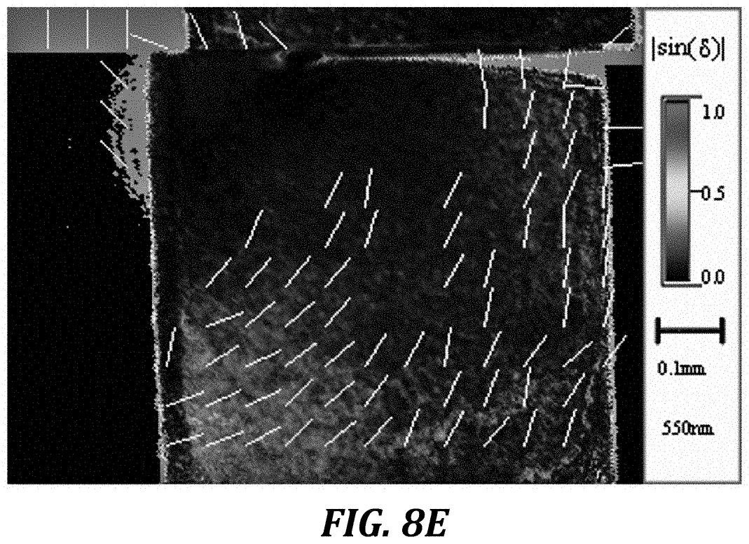

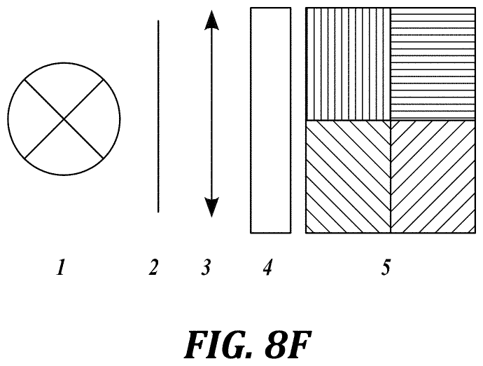

In embodiment of a system 800 in accordance with present disclosure is illustrated in FIGS. 8A and 8B. As shown, the system 800 includes a sensor 802 configured to generate a signal based on optical anisotropy of light 806 received by the sensor 802 from the film 818. In the illustrated embodiment, the sensor 802 includes a beam splitter 808 configured to split light 806 reflected from, for example, a PDLC film 818. As shown, the beam splitter 808 in conjunction with a number of mirrors 810 directs the light 806 from a sample 818 to a number of linear polarizers 812. In the particular embodiment shown, the sensor 802 includes four linear polarizers 812 aligned at 0°, 45°, 90°, and 135°, respectively.

The polarized light source 814 can be any light source configured to emit polarized 806 light. In an embodiment, the polarized light source 814 is configured to emit circularly polarized light 806. By obtaining four intensity measurements of the elliptically polarized light through linear polarizers 812 oriented at 0°, 45°, 90° and 135° with respect to a horizontal reference, the magnitude of birefringence and extinction angle of the sample can be determined.

As schematically illustrated in FIG. 8B, the system 800 can include a light source 814 configured to emit polarized light, such as circularly polarized light, through a diffuser 816 and a polarizer 824. In an embodiment, such as where the light source 814 emits circularly polarized light, the polarizer 824 is a circular polarizer 824. In the illustrated embodiment, the light source 814 is positioned to emit polarized light through a sample 818, such as a PDLC film 818 in accordance with an embodiment of the present disclosure.

A similar system 800 for measuring shear stress through transmission of polarized light 806 through a sample 818, is illustrated in FIG. 8C. In the illustrated embodiment, the system 800 is shown to include a lamp 814 configured to emit polarized light 806 through a diffuser 816, a circular polarizer 824, and the test sample 818 positioned in a wind tunnel 820. In an embodiment, the test sample 818 is a PDLC film 818 in accordance with an embodiment of the disclosure. The system 800 is shown to further include a sensor 802 in the form of a QuadView CCD camera 802 positioned to receive light 806 transmitted through the test sample 818. In an embodiment, the QuadView CCD camera 802 is an example of the sensors 802 described further herein with respect to FIGS. 8A and 8B.

While systems 800 including a sensor 802 in the form of a QuadView CCD camera 802 are described it will be understood that other configurations are possible. In an embodiment, the system 800 includes polarization cameras that have several, such as four, linear polarizers superposed on each pixel. In this manner, such a system 800 eliminates the need for the QuadView unit.

While systems 800 for transmission measurement of PDLC films are illustrated with respect to FIGS. 8B and 8C, other embodiments are possible, such as where the light source 814 is positioned to emit polarized light 806 onto the sample 818, where the sensor 802, including a beam splitter 808 and polarizers 812 and a sensor 802, such as a CCD camera 804, are positioned to receive reflected light 806 from the sample 818. Such a system 800 is illustrated in FIG. 8D, where an LED lamp 814 is positioned to emit polarized light 806 through a lens and circular polarizer 824 and onto a test sample 818, such as a PDLC film 818 in accordance with an embodiment of the present disclosure, disposed in a wind tunnel 820. As shown, polarized light 806 is reflected off of the test sample 818 and onto the sensor 802 including a QuadView CCD camera.

Referring back to FIG. 8B, in the illustrated embodiment, the system 800 is shown to include a controller 822 operatively coupled to the polarized light source 814 and the sensor 802. The controller 822 can include logic to choreograph the operation of components operatively coupled thereto, such as in performing methods of the present disclosure.

In an embodiment, the sensor 802 is configured to generate a signal based upon birefringence of the light 806 received by the sensor 802 from the film 818. In this regard, in an embodiment, the controller 822 including logic that, when executed by the controller 822, causes the system 800 to perform operations including: emitting polarized light 806 with the polarized light source 814; and generating an optical anisotropy signal with the sensor 802 based upon optical anisotropy of the light 806 received from the film 818. As discussed elsewhere herein, such optical anisotropy can include birefringence, scattering, and the like, which can be measured by the sensor 802.

In an embodiment, the controller 822 includes further logic that, when executed by the controller 822, cause the system 800 to perform operations including: correlating an amount of optical anisotropy from the film 818 with an amount of shear stress on the film 818; and outputting a shear stress signal based upon the optical anisotropy signal and indicating an amount of shear stress on the film 818. In an embodiment, such a correlation is based upon application of a known amount of shear stress applied to the film 818 and a measured response to the known shear stress. In this way, the system 800 is configured to generate a shear stress signal based upon a known control signal.

In an embodiment, the polarized light source 814 is configured to emit circularly polarized light 806. In such an embodiment, the optical anisotropy signal is based upon a comparison of the circularly polarized emitted by the light source 814 to elliptically polarized light received by the sensor 802. Such a comparison is suitable to determine an amount of shear stress on the PDLC film 818. In this regard, the more elliptically polarized the light, generally to more shear stress is affecting the PDLC film 818 or test sample 818.

In an embodiment, the shear stress signal includes a component indicating a magnitude of the shear stress and a direction of the sheer stress on the film 818, such as is shown in FIG. 8E. In an embodiment, the magnitude and direction of shear stress indicated by the system 800 is based upon measured optical anisotropy, such as measured birefringence.

### Methods

In another aspect, the present disclosure provides a method of measuring an amount of sheet stress on a surface. In an embodiment, the method includes the use of one or more of a PDLC film or a system of the present disclosure.

In an embodiment, the method begins with exposing the surface to shear stress, wherein the surface is coated with a PDLC film. As discussed further herein, such a surface can include a surface of an airplane, an automobile, a train, or other vehicle. In other embodiments, the surface is a surface of a medical or other device, such as a microfluidic device. In an embodiment, the surface comprises glass, steel, aluminum, or a combination thereof. In an embodiment, exposing the surface to shear stress includes flowing air over the surface.

In an embodiment, the film comprises an optically transmissive polymer matrix; and a liquid crystal dispersed in the optically transmissive polymer matrix is disposed on the surface. Such a film can be a PDLC film as discussed further herein with respect to the PDLC films and systems of the present disclosure. In an embodiment, at least a portion of the liquid crystal protrudes from or is exposed on a side of the optically transmissive polymer matrix opposite the surface. In an embodiment, exposing the surface to shear stress includes exposing the film to the shear stress.

In an embodiment, exposing the surface to shear stress is followed by illuminating the film to polarized light. In an embodiment, exposing the surface to shear stress is concomitant with illuminating the film to polarized light. As discussed elsewhere herein, in an embodiment the polarized light is circularly polarized light.

In an embodiment, illuminating the film to polarized light is followed by measuring an amount of optical anisotropy of light reflected off of or transmitted through the film. In an embodiment, the amount of optical anisotropy is based upon an amount of birefringence in the polarized light reflected off of or transmitted through the film. In an embodiment, the amount of optical anisotropy is based upon an amount of scattering of the polarized light reflected off of or transmitted through the film.

In an embodiment, measuring an amount of optical anisotropy is followed by correlating the amount of optical anisotropy with an amount of sheer stress. Such a correlation can be based upon measured amounts of optical anisotropy and known amounts of shear stress. In an embodiment, correlating the amount of optical anisotropy with an amount of sheer stress includes a comparison of previously measured amounts of optical anisotropy based on known amounts of shear stress and measured amounts of optical anisotropy of the film.

In an embodiment, the steps of exposing the surface to shear stress; illuminating the film with polarized light; measuring an amount of optical anisotropy in light reflected off of or transmitted through the film; and correlating the amount of optical anisotropy with an amount of sheer stress are repeated a number of times. In an embodiment, the amount of shear stress applied to the film is roughly the same, such as in generating a larger data set for a single amount of shear stress applied to the PDLC film. In an embodiment, the amount of shear is varied, such as in generating a response curve of the surface to shear stress by varying, for example, wind speed. As discussed further herein, the PDLC films of the present disclosure may generally be used repeatedly to determine an amount of shear stress.

While the processes or steps are described in a particular order, the order of method steps can be in any relative order.

In certain embodiments, the processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

### EXAMPLES

### Example 1: Materials and PDLC Film Preparation

The nematic LC-E7 was obtained from Jiangsu Hecheng Display Technology Co.

LTD. Polymethylmethacrylate (PMMA) and chloroform were purchased from Sigma-Aldrich. Poly(dimethylsiloxane) (Mw=97,300 g/mol) were purchased from Fluka Analytical. Silicone elastomer SYLGARD® 184 (including two parts—base part and curing agent) was bought from Dow-Corning. The solution was prepared by mechanically stirring the mixture containing proper amounts of polymer, LC, and solvent (chloroform) using a magnetic bar for 2 hours at room temperature (20° C.). The homogeneous solution was sprayed using a commercial airbrush (Paasche Model H Single Action Airbrush) onto testing object surface at an air pressure of 20 psi and at a spray distance of 20 cm. The deposited surfaces include clean glass plates, aluminum plates polished with sandpapers (different grits), a steel plate and a piece of mirror. The coating thickness was varied based on the number of air brush passes and deposition duration time. The thickness (h) is also roughly calculated by equation h=m/A, where m is the mass of deposited film and A is coated area, the density of PDLC is roughly counted as 1 g/cm³.

### Example 2: Real-Time Dynamic Birefringence Measurement System

The dynamic anisotropy change of PDLC coatings is monitored, processed and displayed through an instrument called MilliView. The Milliview and the theory behind are developed and illustrated by Dr. Werner Kaminsky, et al., at the Department of Chemistry of University of Washington—Seattle. MilliView utilizes the transformation of circularly polarized light into elliptically polarized light as it passes through a birefringent sample. The macroscopic birefringence measurement was performed using the QuadView system (developed by Optical Insights), as sketched in FIG. 8A. The device has a four-sided prism and four mirrors; a single image can be split into four and be projected through four linear polarizers on a single CCD camera.

The schematic of the “MilliView” system is given in FIG. 8B. Four linear polarizers in FIG. 8B are aligned at 0°, 45°, 90°, and 135°, respectively. By obtaining four intensity measurements of the elliptically polarized light through linear polarizers oriented at 0°, 45°, 90° and 135° with respect to a horizontal reference, the magnitude of birefringence and extinction angle of the sample can be determined.

The images were processed by the software to yield three simultaneous images: birefringence |sin δ|, extinction angle φ, and intensity data I/I₀. Before beginning measurement, a background check would be performed to set the initial birefringence to nominally zero. Throughout the test, the birefringence, extinction angle, and intensity change data were visible in nearly real-time. Color-coded bars indicated the relative values, while clicking and dragging a box over the image gave the exact average value. Images of the birefringence were saved and analyzed using MilliView's “Analyse Data” function.

By measuring the intensity of light through the sample in the presence of a shear force and relating that back to an initial light intensity measurement, the birefringence of a sample can be calculated. Wood and Glazer proposed a method to achieve this using the combination of a quarter wave plate and a linear polarizer to create a circular polarizer.

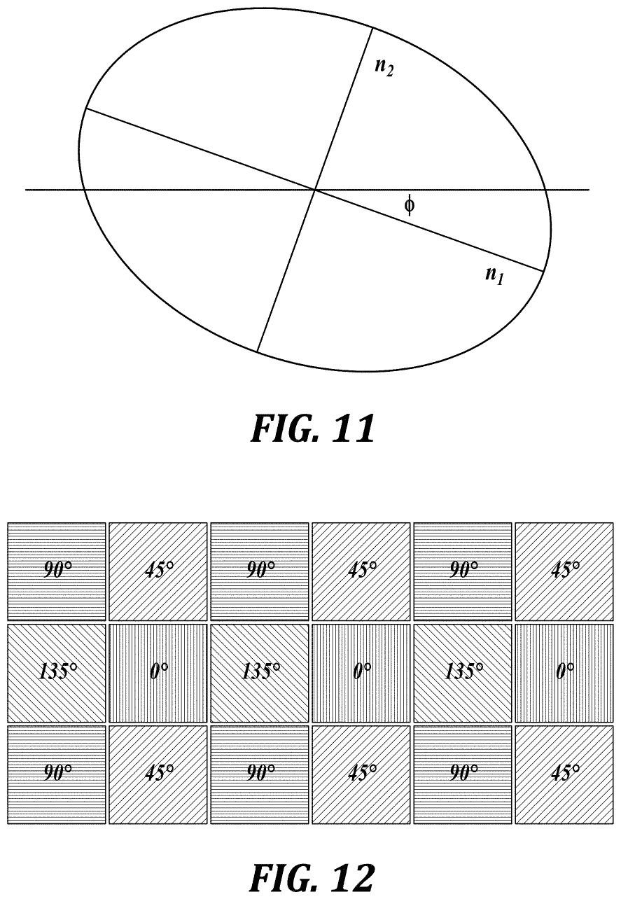

When circular polarized light passes through a birefringent media, each of the two refractive indices gives different phase retardations to the light. This phenomenon changes circular polarized light into elliptically polarized light, with the long and short axis proportional to the two distinct refractive indices. Thus, the birefringence can be determined by measuring the properties of the elliptically polarized light. This elliptically polarized light also contains directional information. Birefringent material inherently contains an extinction angle. If the material placed at the extinction angle no light would be able to pass through, since the two reflected lights lines up with the angles of the two crossed linear polarizers. This phenomenon occurs four times every rotation placed π/2 apart. In elliptically polarized light, this extinction angle is shown in FIG. 11. It can be used to relate back to the direction of the shear stress, since this extinction angle describes the direction the ellipse is pointing to. Circularly polarized light that is passed through a birefringent surface will then become elliptically polarized. The light is then passed through a linear analyzer that rotates with a frequency ω. The measured intensity is then given by Equation 1, where I₀ is the initial intensity, t is time, and δ is the phase shift given in Equation 2, where λ is the wavelength of light, Δn is the birefringence, and L is the material thickness. As seen in FIG. 11, φ is the angle between the horizontal and the larger index of refraction, referred to as the extinction angle.

$$\begin{matrix}I = \frac{1}{2} {I}_{0} [ 1 + sin [ 2 ( ωt - ϕ ) ] sin δ ] & ( 1 ) \\ δ = \frac{2 π}{λ} Δ n L & ( 2 )\end{matrix}$$

The birefringence Δn is a sinusoidal function of the difference in indices of refraction of the liquid crystal, as seen in Equation 3, where nₑ and nₒ are the extraordinary and ordinary indices of refraction, respectively, and θ is the angle between the liquid crystal director axis and the substrate normal.

Δn≈(nₑ−nₒ)sin² θ (3)

By taking the intensity measurements at N discrete angles, ωt is replaced by αᵢ, as seen in Equation 4, where αᵢ are the angles used, i ranging from 1 to N. This removes the need to use a continuously rotating polarizer.

Iᵢ=½I₀[1+sin [2(αᵢ−φ)] sin δ] (4)

Equation 4 can be linearized into Equation 5 using a trigonometric conversion, where a₀, a₁, and a₂ are given in Equation 6.

Iᵢ=a₀+a₁ sin 2aᵢ+a₂ cos 2aᵢ (5)

a₀=½I₀, a₁=½I₀ sin δ cos 2φ, a₂=½I₀ sin δ cos 2φ (6)

The linearization removes the need for explicit matrix inversion, as the system of equations becomes diagonal when intensities are measured for angles 2αᵢ covering the full period of the sinusoidal functions. Equation 6 can then be rewritten in terms of the measured intensity, as seen in Equation 7.

$${a}_{0} = {\sum }_{i = 1}^{N} \frac{1}{N} {I}_{i} , {a}_{1} = {\sum }_{i = 1}^{N} \frac{2}{N} {I}_{i} sin 2 {α}_{i} , {a}_{2} = {\sum }_{i = 1}^{N} \frac{2}{N} {I}_{i} cos 2 {α}_{i} \qquad ( 7 )$$

Kaminsky proposed the use of four angles ranging from 0° to 135° in 45° increments. Setting the αᵢ values to 0°, 45°, 90°, and 135°, Equation 7 can be rewritten as Equation 8

a₀=Σᵢ₌₁⁴¼Iᵢ, a₁=½(I₂−I₄), a₂=½(I₁−I₃) (8)

The four intensities come from the four measured intensities at the corresponding angles. The birefringence then becomes a function of the phase shift only, and is proportional to |sin δ|, which is given in Equation 9.

$$\vert sin δ \vert = \frac{1}{{a}_{0}} \sqrt{{a}_{1}^{2} + {a}_{2}^{2}} \qquad ( 9 )$$

Thus, it can be shown that using only four angles the birefringence of a sample can be measured. Furthermore, the extinction angle can be calculated as in Equation 10.

$$ϕ = \frac{π}{2} + s g n ( {a}_{2} ) \frac{1}{2} {cos}^{- 1} ( \frac{- {a}_{1}}{\sqrt{{a}_{{1}^{2}} + {a}_{{2}^{2}}}} ) \qquad ( 10 )$$

The transmittance of the sample is simply given by a₀. As seen in Equation 8, a₀ computes the averaged light intensity across the four angles. This value is also needed to make the birefringence and extinction angle independent of light intensity, and the signal to noise ratio is improved by 10 to 100 times compared with the rotating polarizer approach.

Based on this algorithm, Kaminsky et al. (Kaminsky, W., Gunn, E., Sours, R., Kahr, B. “Simultaneous false-colour imaging of birefringence, extinction and transmittance at camera speed.” Journal of Microscopy 228, 2007: 153-164) then developed a real time birefringence and extinction angle measurement system called “MilliView”, shown in FIG. 8A. It utilizes an image-multiplexing device that has been developed by Optical Insights, LLC that makes real-time birefringence and extinction measurements a reality. The device, known as Quad-View, is essentially a camera lens fitted with a 4-sided prism. This prism splits the sample image into four reflections that are mirrored back to a CCD camera. The resulting four simultaneous images are then focused on the surface of the camera as an array. The Quad-View is fitted with four linear polarizers set at the aforementioned angles thus eliminating the need for mechanical rotation. FIG. 8B demonstrates the functional groups of the Quad-View system. This system, “MilliView”, allowed for real-time intensity-based shear measurements using shear-sensitive liquid crystals.

This approach with using the Quad-View is definitely of value for use in wind tunnel applications, since the CCD camera labelled in FIG. 8A can be a Phantom or Photron high-speed camera, which would allow for capturing time-dependent properties.

For our present investigations, we have identified a polarization camera (JAI GO-5100MP-USB) that is a 5.1 megapixel camera, containing 4 different polarizing nano-wire grids (0°, 45°, 90°, 135°) applied to each 4-pixel blocks (see FIG. 12). The camera can output in 8, 10 or 12-bit monochrome output, though currently we are using it in 8-bit output mode. The camera outputs images at 74 frames per second and has a global shutter. Built-in functions allow for calculating the polarization angle (this will tell us the direction of the shear), and the polarization ratio (this will tell us the magnitude of the shear). With the camera, the Quad-View can be completely removed, and the experimental setup schematic is as shown in FIG. 8F; this is the setup that will be used for our Phase I studies. It should be pointed out that by changing the ROI of this camera, we can increase the image acquisition frame rate acquisition, for example in 8-bit mode: 200 fps (685p×2), 355 fps (514p×2), 1,419 fps (257p×2), 5,722 fps (128p×2), 22,888 fps (64p×2), 91,553 fps (32p×2); and in 10-bit mode: 160 fps (685p×2), 284 fps (514p×2), 1,136 fps (257p×2), 4,578 fps (128p×2), 18,311 fps (64p×2), 73,242 fps (32p×2).

### Example 3: Wind Tunnel Set-Up

Both transmission mode and reflection mode setups are sketched in FIGS. 8C and 8D, respectively. In all setups, the light (from 150 W halogen lamp) propagates through a diffuser and a circular polarizer before passing through the tested sample.

The wind tunnels where the tests were operated include a lab wind tunnel (0-80 mph, Jet Stream 500) and a 3′ by 3′ wind tunnel (0-130 mph, Kirsten wind tunnel at the central Seattle campus of the University of Washington).

### Example 4: PDMS and E7

Currently, one of the most studied soft or elastic polymers is polydimethylsiloxane (PDMS). PDMS is commercially available, stable, inexpensive, and easy to use. To enlarge the magnitude as well as the sensitivity, we conducted a series of experiments with PDMS.

PDLC films were made by spraying a homogeneous solution of PDMS (5 wt. %) and E7 (5-15 wt. %) dissolved in chloroform onto glass plates. The PDLC films with different weight ratios of PDMS and E7 (such as, PDMS/E7=1:1, 1:2, and 1:3) were prepared using an airbrush. The PDLC films containing different weight ratio of PDMS and E7 present different size and different overall alignment behavior of LC droplets. With less LC loading (PDMS/E7=1:1, w/w), the E7 droplets are fully embedded inside the polymer matrix. As the LC loading ratio increases (PDMS/E7=1:2, or 1:3, w/w),), the polymer matrix does not cover the E7 droplets completely, leading to partially exposed PDLC.

The response of the PDLC film to air flow show reversible signals in a wind tunnel. The optical response is the result of the alignment of the LC domains producing an increasing birefringence. The optical effects increase as the air speed increases from 20 mph to 60 mph.

The radial structure demonstrates that the liquid crystals have a perpendicular alignment on the PDMS interface, as shown in FIG. 2A.

As shown in FIG. 2C-2H, the PDLC films containing different weight ratio of PDMS and E7 may present different size and different overall alignment behavior of LC droplets. With less LC loading (PDMS/E7=1:1, w/w), the E7 droplets are fully embedded inside the polymer matrix. As the LC loading ratio increases (PDMS/E7=1:2, or 1:3, w/w), the polymer matrix cannot cover the E7 droplets completely, leading to partially exposed PDLC.

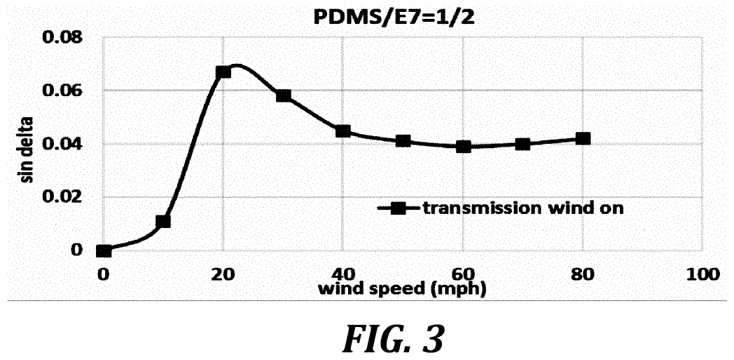

The measured average sin δ values decrease as the wind speed increases from 20 mph to 60 mph, as shown in FIG. 3. This is probably because at higher flow speed, air flow separation occurs starting at the leading edge of the glass slide and the airflow bypasses the PDLC sample.

From above, we can see that the partially exposed PDLC films are sensitive to air flow. The mechanism may be illustrated in FIG. 7B, both the LC at the interface of PDMS and at the interface of air has a preferred homeotropic alignment. When there is air flow crosses its film surface, the induced shear stress would deform the homeotropic alignment and cause the tilted alignment and birefringence.

As the air flow is on, other than birefringence in the PDLC films, the shear stress direction can also be displayed in the Milliview interface at the same time. As shown in FIG. 8E, the white vectors indicate the shear stress direction.

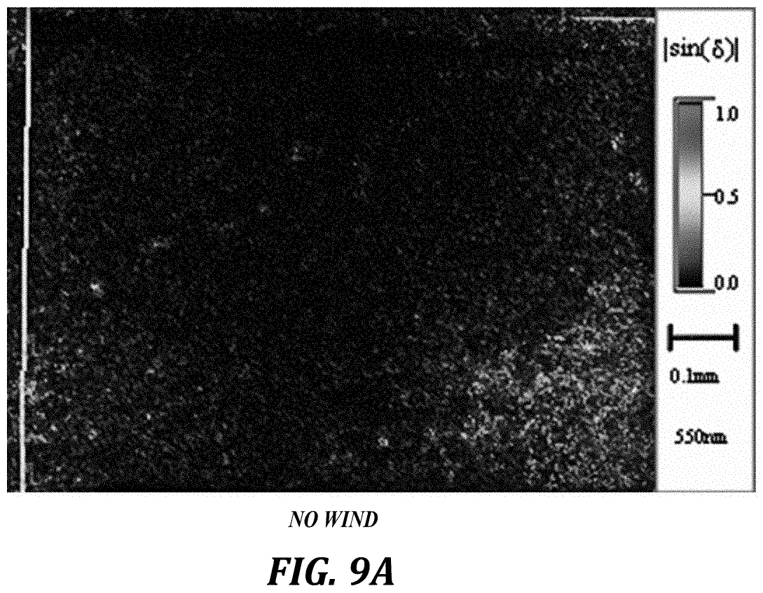

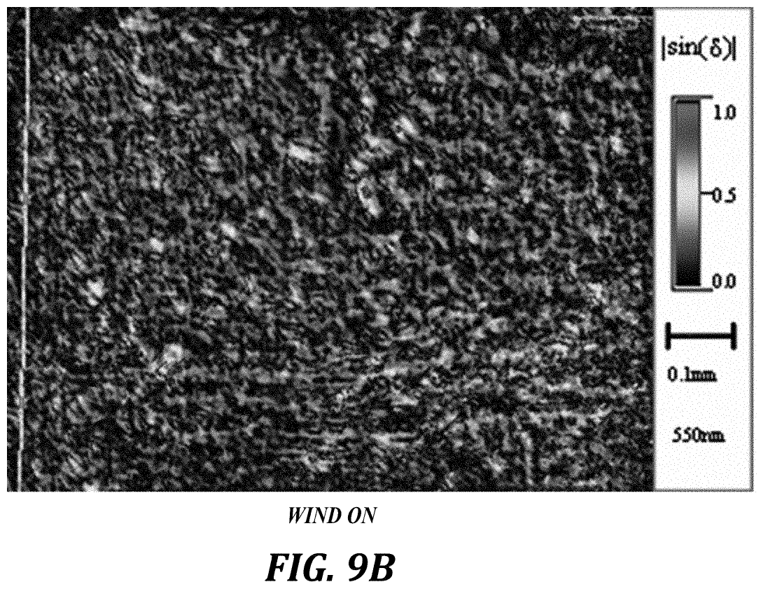

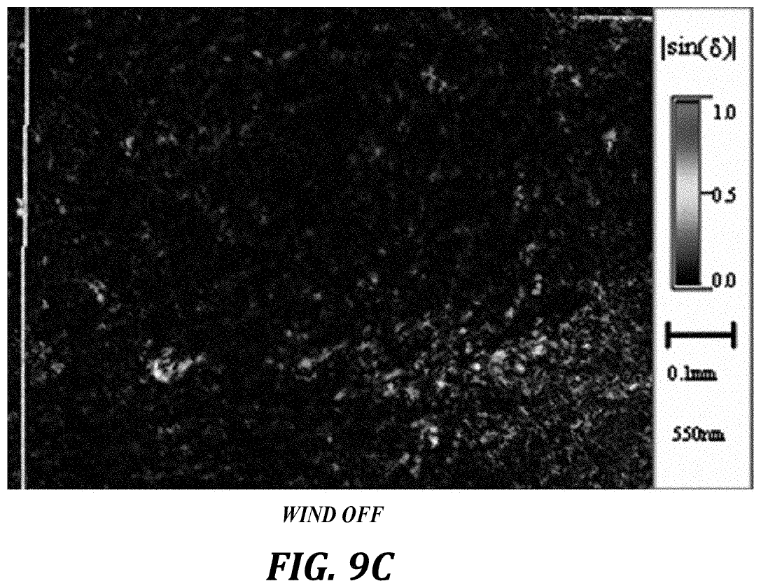

The PDLC (PDMS:E7=1:2, w/w) was prepared by directly spray solution (5% PDMS+10% E7+85% chloroform) onto the airfoil. When the wind (130 mph) is on, the PDLC show large signal (appeared bright as shown in FIG. 9B) compared to when no wind is applied to the airfoil, as shown in FIG. 9A. However, the residual color shown in FIG. 9C indicates the PDLC film is not completely reversible when the wind is off. This may be because the large shear stress at 130 mph has a permanent impact on the PDLC (some exposed LC droplets are blown away by wind), resulting in the non-reversible change.

The silicone elastomer is a common soft and flexible material. Its elasticity can be controlled by cross-linking. Usually, the higher density of cross-linking, the more rigid. By controlling the cross-linking of PDMS matrix in the PDLC, the PDLC with different elasticity can be realized. We prepared 4 PDLCs with Sylgard 184 PDMS with different base and curing agent mixing ratios, as shown in Table 0.1.

TABLE 0.1
Components and composition for solution prepared for elasticity study.

| Sample # | Silicone elastomer base | curing agent | E7 |
|---|---|---|---|
| A | 20 | 1 | 1 |
| B | 40 | 1 | 2 |
| C | 60 | 1 | 3 |
| D | 80 | 1 | 4 |

The curing (crosslinking) of Sylgard 184 PDMS is achieved using vinyl ended polymers (base) with Si—H groups carried by functional oligomers (curing agent.

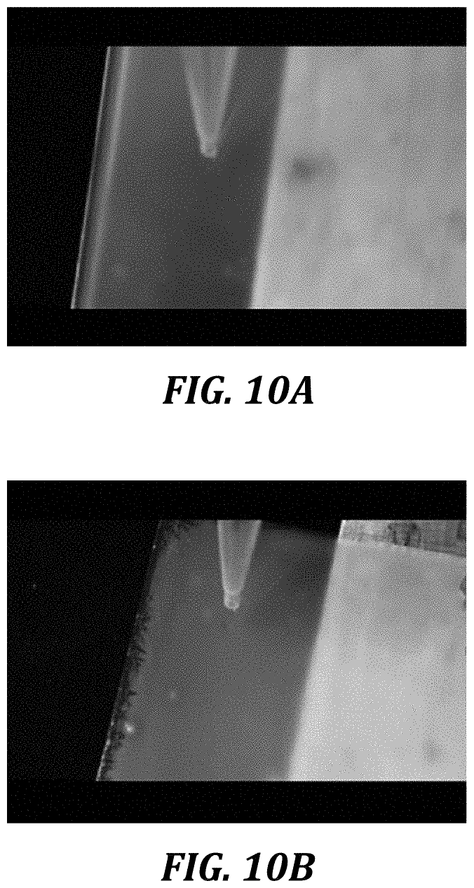

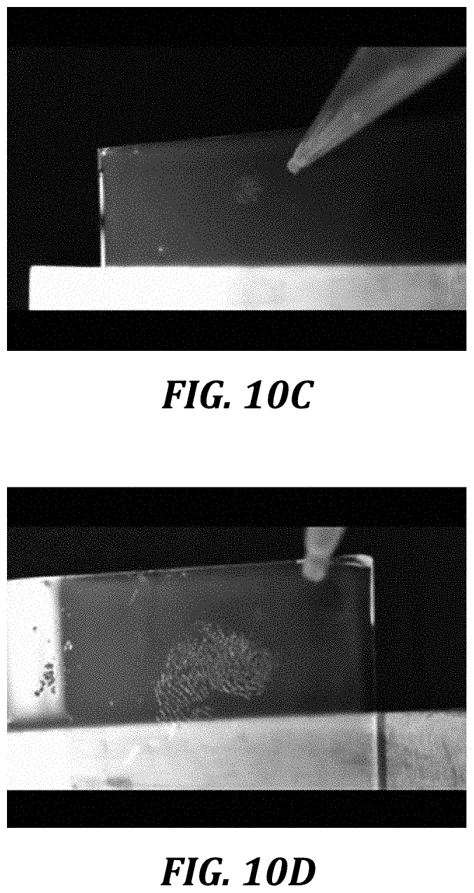

The softness of PDLC was roughly estimated with the air flow emanating from a nozzle (18 gauge) connected with compressed nitrogen (20 psi) at a distance of 3 cm, as shown in FIGS. 10A-10D.

For the softest PDLC (PDMS base:curing agent=80:1) among those 4 formulations, we tested its birefringence related to deformation via utilizing simple optical set-up. When the air flow (the flow direction is 45° to the polarizer direction) is on, the transmission is high, because the LC droplets in the film are deformed and aligned in preferred direction, suppressing light scattering. When the air flow is off, the deformed PDLC returns back to the original state, as indicated by the digital reading from a multi-meter connected to the photodetector.

### CONCLUSION

The partially exposed PDLC made of PDMS and E7 formulation is sensitive to shear stress, and shows reversible measurement in low wind speed range (0-80 mph). The tests with PDLC coating on airfoil in large wind tunnel (130 mph) also show high signal, although some exposed LCs failed to return to original state due to displacement. To match the large shear stress at high velocity, the PDMS based PDLC with different stiffness were prepared. This is realized by different cross-linking density. Although not tested in large wind tunnel yet, its response to airflow emanating from a nozzle causes the reversible light scattering effect. Overall, these results demonstrate the feasibility of utilizing PDLC films as a two-dimensional sensor for shear stress measurement.

### Example 5: PMMA and E7

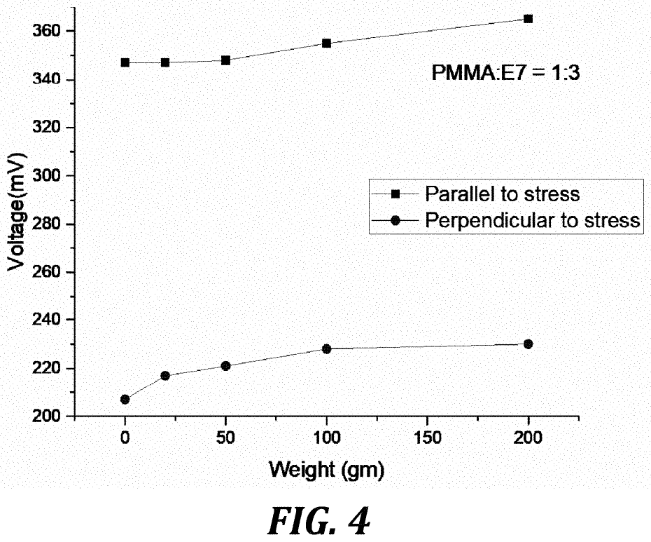

PDLC film were fabricated from solutions of poly(methylmethacrylate) (PMMA, MW 15,000 g/mol) and E7 dissolved in a common solvent such as chloroform. The weight ration of the PMMA/E7 was set at 1:3 respectively. The solution was placed on a glass slide and the solvent evaporated resulting in a white coating of the PDLC on the glass substrates. The resulting substrates were heated to reform a homogeneous solution which is achieved when the films turn clear. A second glass substrate is used to sandwich the film by applying pressure with the thickness controlled by using either particle or film spacers. The resulting cell is cooled to room temperature. Mechanical stress is applied to the resulting cell by holding one substrate stationary while hanging a weight from the second substrate. These films are relatively rigid withstanding applied stress of 200 grams/square inch. See, for example, FIG. 4.

The LC droplets size would be primarily affected by the weight percentage of the LC, as shown in FIGS. 1A and 1B.

The alignment of LC at the PMMA interface is planar (as shown in FIG. 1C), as confirmed by the bipolar droplet orientation (as shown in FIG. 1D).

These two PDLCs with different LC droplets size were tested at transmission mode. The birefringence data collected from the same spot at different wind speeds (0-80 mph) is presented in FIGS. 1F and 1E.

As wind speed went up, the measured birefringence increased. It appears that the PDLC with larger LC droplets (higher LC weight percentage) showed a larger birefringence signal (sin δ). However, it has to be noted that the birefringence values collected from these PMMA/E7 based PDLCs are relatively small (<0.05). The reason may be due to the stiffer PMMA matrix.

### Example 6: NOA 65 and E7

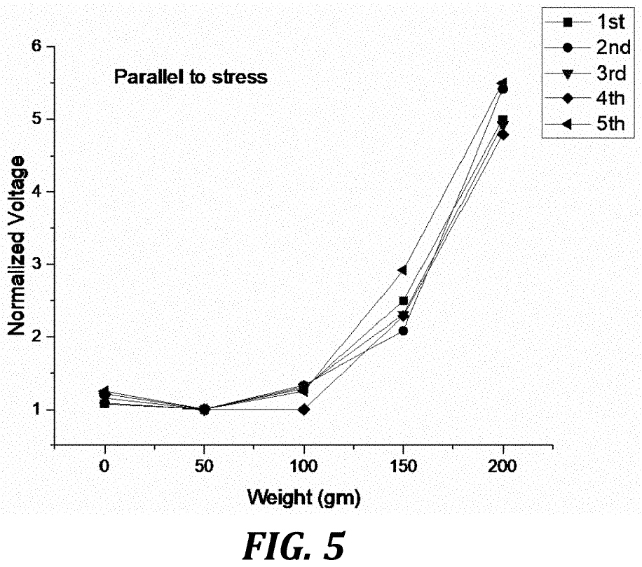

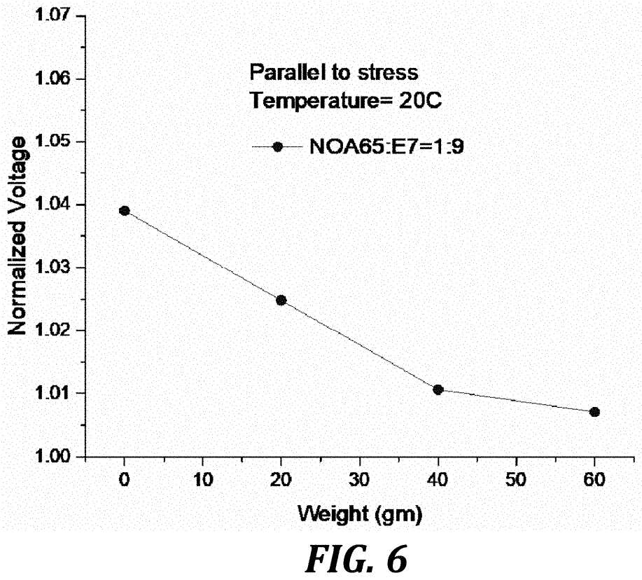

Homogeneous solution of the optical cured polymer, Norland Optical Adhesive (NOA 65) and E7 were formed by mixing at room temperature. The resulting solution was then sandwiched between glass substrates with spacers used to control the thickness. The resulting cells were then exposed to UV light to cure the polymer. The flexibility of the PDLC films was adjusted by varying the concentration of the E7 to the NOA 65. For example, with cells made with NOA65/E7 ratio of 1:9 fully responded with 60 grams/square inch applied, FIG. 5. Changing the ratio to 1:1.5 made a more rigid film which requires more than 200 grams/square inch to fully respond, FIG. 6.

While illustrative embodiments have been illustrated and described, it will be appreciated that various changes can be made therein without departing from the spirit and scope of the invention.

The embodiments of the invention in which an exclusive property or privilege is claimed are defined as follows:

1. A film for measuring shear stress, the film comprising:
an optically transmissive polymer matrix disposed on a substrate; and
a liquid crystal dispersed in the optically transmissive polymer matrix,
wherein at least a portion of the liquid crystal is exposed on a side of the optically transmissive polymer matrix opposite the substrate.

2. The film of claim 1, wherein the liquid crystal is a nematic liquid crystal.

3. The film of claim 1, wherein the liquid crystal is a single-component liquid crystal.

4. The film of claim 1, wherein the liquid crystal dispersed in the optically transmissive polymer matrix defines a plurality of liquid crystal domains distributed within the optically transmissive polymer matrix.

5. The film of claim 4, wherein an average diameter of the plurality of liquid crystal domains is in a range of about 5 μm to about 30 μm.

6. The film of claim 4, wherein an average thickness of the plurality of liquid crystal domains is in a range of about 5 μm to about 10 μm.

7. The film of claim 4, wherein the liquid crystal is radially aligned within the plurality of liquid crystal domains.

8. The film of claim 1, wherein the optically transmissive polymer matrix comprises a polymer selected from the group consisting of poly(dimethylsiloxane), poly(urethanes), poly(methylmethacrylate), poly(styrene), and combinations thereof.

9. The film of claim 1, wherein the optically transmissive polymer matrix is crosslinked with a curing agent, and wherein a weight:weight ratio of an optically transmissive polymer of the optically transmissive polymer matrix to the curing agent is in a range of about 10:1 to about 100:1.

10. The film of claim 1, wherein a weight:weight ratio of the optically transmissive polymer matrix to the liquid crystal is about 0.5:1 to about 5:1.

11. A system for measuring shear stress, the system comprising:
a film comprising:
an optically transmissive polymer matrix disposed on a substrate; and
a liquid crystal dispersed in the optically transmissive polymer matrix,
wherein at least a portion of the liquid crystal is exposed on a side of the optically transmissive polymer matrix opposite the substrate;
a polarized light source positioned to emit polarized light onto the film; and
a sensor configured to generate a signal based on optical anisotropy of light received by the sensor from the film.

12. The system of claim 11, wherein the sensor is configured to generate a signal based upon birefringence of the light received by the sensor from the film.

13. The system of claim 11, further comprising a controller operatively coupled to the polarized light source and the sensor, the controller including logic that, when executed by the controller, causes the system to perform operations including:
emitting polarized light with the polarized light source; and
generating an optical anisotropy signal with the sensor based upon optical anisotropy of the light received from the film.

14. The system of claim 13, wherein the controller includes further logic that, when executed by the controller, cause the system to perform operations including:
correlating an amount of optical anisotropy from the film with an amount of shear stress on the film; and
outputting a shear stress signal based upon the optical anisotropy signal and indicating an amount of shear stress on the film.

15. The system of claim 13, wherein the shear stress signal includes a component indicating a magnitude of the shear stress and a direction of the sheer stress on the film.

16. The system of claim 11, wherein the polarized light source is configured to emit circularly polarized light, and wherein optical anisotropy signal is based upon a comparison of the circularly polarized emitted by the light source to elliptically polarized light received by the sensor.

17. The system of claim 11, wherein the film is a film according to claim 1.

18. A method of measuring an amount of sheet stress on a surface, the method comprising:
exposing the surface to shear stress, wherein a film comprising an optically transmissive polymer matrix; and a liquid crystal dispersed in the optically transmissive polymer matrix is disposed on the surface;
illuminating the film with polarized light;
measuring an amount of optical anisotropy in light reflected off of the film; and
correlating the amount of optical anisotropy with an amount of sheer stress.

19. The method of claim 18, wherein at least a portion of the liquid crystal is exposed on a side of the optically transmissive polymer matrix opposite the surface.

20. The method of claim 18, wherein exposing the surface to sheer stress includes exposing the surface to air flow over the surface.
